(19) United States
(12) Patent Application Publication
(10) Pub. No.: US 2010/0080318 A1
(43) Pub. Date: Apr. 1, 2010

(54) SYSTEM AND METHOD FOR IMPROVED FREQUENCY ESTIMATION FOR HIGH-SPEED COMMUNICATION

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/522,937

(22) PCT Filed: Jan. 14, 2008
(86) PCT No.: PCT/IB2008/050118

§ 371 Date: Jul. 13, 2009

Related U.S. Application Data
(60) Provisional application No. 60/885,158, filed on Jan. 16, 2007.

(51) Int. Cl. H04B 15/00; H04L 27/00

(52) U.S. Cl. 375/285; 375/295

(57) ABSTRACT

A system and method is provided for improved frequency error estimation in a high-frequency data communication system. In an embodiment, a method for providing improved frequency error estimation comprises performing encoding, interleaving and symbol mapping on original information bits to form a data stream of modulated information symbols; inserting pilot symbols into the data stream at progressively longer time intervals and transmitting the data stream as a radio signal from a data transmitter to a receiver. The method further comprises using the received pilot symbols, transmitted at progressively longer time intervals to perform frequency error estimation. In certain embodiments, the received pilot symbols may also be used to perform improved channel estimation updates.

### CROSS REFERENCE TO RELATED APPLICATIONS

This application claims the benefit of prior filed, co-pending U.S. provisional application: Ser. No. 60/885,158, filed on Jan. 16, 2007.

### BACKGROUND OF THE INVENTION

1. Field of the Invention

The invention relates generally to the field of data communications and more particularly, but not exclusively, to a system and method of transmitting a data signal.

2. Description of the Related Art

Future high-speed wireless communication systems are expected to occur at higher frequencies, e.g., 60 Ghz. One of the challenges associated with such systems is relatively high frequency mismatch between transmitter and receiver. At 60 Ghz, this mismatch can be up to 2.4 MHz, using a commercially available crystal of 20 ppm error at both the transmitter and receiver. This mismatch is up to ten times higher than that of today's 5 GHz WLANS.

Conventional packet structures, such as those used for WLANs for high speed communications, do not provide an accurate estimation of frequency error. This is because conventional packet structures contain a preamble sequence only at the beginning of the data. While this structure leads to performance that is adequate at low frequencies, e.g., 5 Ghz as the expected frequency error will not exceed 200 KHz (40 ppm). However, using a similar structure will not lead to good performance for systems at high frequency, e.g., 60 GHz. In order to get good estimation accuracy with high-speed systems, very long preambles are required at the beginning of the packet. However, this results in a very inefficient system. A conventional method to improve performance is to insert preambles regularly with data. These repeated preambles can be used not only for the frequency error estimation but also for other purposes such as channel estimation updates. While this structure improves performance, it is not adequate for high-frequency applications, e.g., 60 Ghz. Moreover, the regularly inserted preambles increase overhead, thereby reducing channel efficiency.

A need therefore exists for a frequency error estimation system and method having acceptable overhead for use at high frequencies.

### SUMMARY OF THE INVENTION

Therefore, the present invention has been made in view of the above problems. Accordingly, the present invention provides a system and method for providing improved frequency error estimation in a data communication system. In an embodiment, a data structure is provided comprising a sequence of pilot symbols to be inserted into a sequence of data symbols for wireless transmission from a data transmitter to a data receiver. In accordance with a method of the invention, the pilot symbols are inserted into the sequence of data symbols at progressively lower repetition rates (i.e., progressively larger repetition time intervals). By transmitting the pilot symbols at an initial high repetition rate of transmission, a data receiver is able to make a course estimation of the frequency error. Thereafter, as the repetition rate is progressively lowered, finer estimates of the frequency error are obtained. The sequence of pilot symbols, transmitted in the manner described, are useful, not only for providing improved frequency error estimates, but also for providing improved channel estimation updates.

Various aspects and embodiments of the invention are described in further detail below.

### BRIEF DESCRIPTION OF THE DRAWINGS

These and other objects, features and advantages of the invention will be apparent from a consideration of the following Detailed Description Of The Invention considered in conjunction with the drawing Figures, in which:

FIG. 1 is a functional block diagram of one embodiment of a data transmitter;

FIG. 2 is one embodiment of a packet structure that may be employed for data packets transmitted by a data transmitter;

FIG. 3 is a functional block diagram of one embodiment of a portion of data receiver focusing on the frequency error estimation and correction portion;

FIG. 4 is a more detailed block diagram of the Frequency Estimation block 308 of the data receiver of FIG. 3; and

FIGS. 5 & 6 illustrate two different simulation results for three system configurations corresponding, respectively, a first and second prior art system configuration and a system configuration according to an embodiment of the invention.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Overview

The invention has particular, but not exclusive, application, in reducing the relatively high frequency mismatch that occurs between a transmitter and receiver communicating at high frequencies, thereby improving frequency error estimates for high-speed communication. Beneficially, the improved frequency error estimates are realized at a reasonable overhead.

As is well known, a conventional way of estimating frequency error in wireless communication systems is through auto-correlation of the received data. For example, a transmitter transmits a signal s(t). After down conversion by an RF unit, excluding multipath, a received signal can then be represented by,

r(t)=s(t)eⁱ(2πf^{_{Δ}}^{t+α})+n(t) Eq. [1]

Where f_{Δ} is the frequency error (i.e., mismatch of the transmitter and receiver oscillator), α is phase offset, and n(t) is additive noise.

A common method of estimating this frequency error f_{Δ} is by transmitting two identical sequences within a known time interval. At the receiver, a delayed-auto-correlation operation is performed to compute the frequency error as follows.

The discrete time equivalent computation of the frequency error estimation can be described by

$$f ( n ) = {\sum }_{m = 1}^{N} r ( nT - mT ) {r}^{*} ( nT - mT - KT ) \qquad Eq . [ 2 ]$$

where T is the sampling rate and KT is the repetition interval of the sequence and N is the length of the sequence. Here, it is assumed that the integration is done only on the repeatedly transmitted part only. As a result, the following is found at the point that the repeated portions overlap.

f(n)=δe^{i2πf}^{_{Δ}}^{KT}+n(n) Eq. [3]

where δ is a constant Taking the angle of the above, one obtains the frequency error as

$${f}_{Δ}^{1} = {f}_{Δ} + \frac{{n}^{″}}{2 π KT} \qquad Eq . [ 4 ]$$

Where n″ is a noise term. It should be noted from equation (4) that the accuracy of the frequency error is heavily influenced by the noise term and the interval KT. The noise term is more or less constant. One method of reducing the negative effect the noise term is to increase the interval KT. However, this interval cannot be increased without causing other adverse effects. For the above estimation to work, the expected angular rotation should not exceed 360° so that unambiguous estimation can be performed, i.e., f_{Δ}KT≦1. In order to fulfill this constraint, it is necessary to have KT less than the inverse of the frequency error i.e.,

KT<1/f_{Δ} Eq. [5]

Thus, KT needs to be dimensioned for the maximum expected error. In practice, it should be much smaller that the inverse of the expected frequency error. For example, for an ultra-wide-band (UWB) application, KT=300 ns. In theory, this allows estimation of up to a 3.3 MHz clock offset. However, the accuracy of the estimation depends on noise, which calls for larger KT values.

It is therefore shown that two conflicting requirements exist. More particularly, the repetition interval KT must be small to allow for the estimation of a large frequency error and the repetition interval KT must be large to obtain an accurate estimation error.

The conflicting requirements described above may be overcome for systems operating at frequencies at relatively low speeds, e.g., 5 GHz or lower, by setting the maximum tolerable frequency error to a certain value, such as 200 KHz. By limiting the maximum tolerable frequency error in this way, a suitable value of KT may be found. Accordingly, crystal oscillators with 20 ppm specification may be used, which are available at low cost.

Unfortunately, for communication systems operating at high speeds, e.g., on the order of 60 GHz, the conflicting requirements are not easily met. For such high speed communication systems, on the order of 60 GHz, the use of a 20 ppm crystal results in an unacceptable frequency error of 2.4 MHz. This does not lend itself to find a suitable value of KT that is appropriate for both accuracy and larger magnitude estimation. One possible solution is to use a crystal oscillator with a 2 ppm specification. This requirement, however, is undesirable from a cost perspective.

The invention addresses the problem of finding a suitable value of KT that is appropriate for both accuracy and larger magnitude estimation by providing a system and associated method that provides improved frequency error estimates for high-speed communication systems (e.g., 60 GHz) at a reasonable overhead. An exemplary embodiment is described as follows.

Transmitter

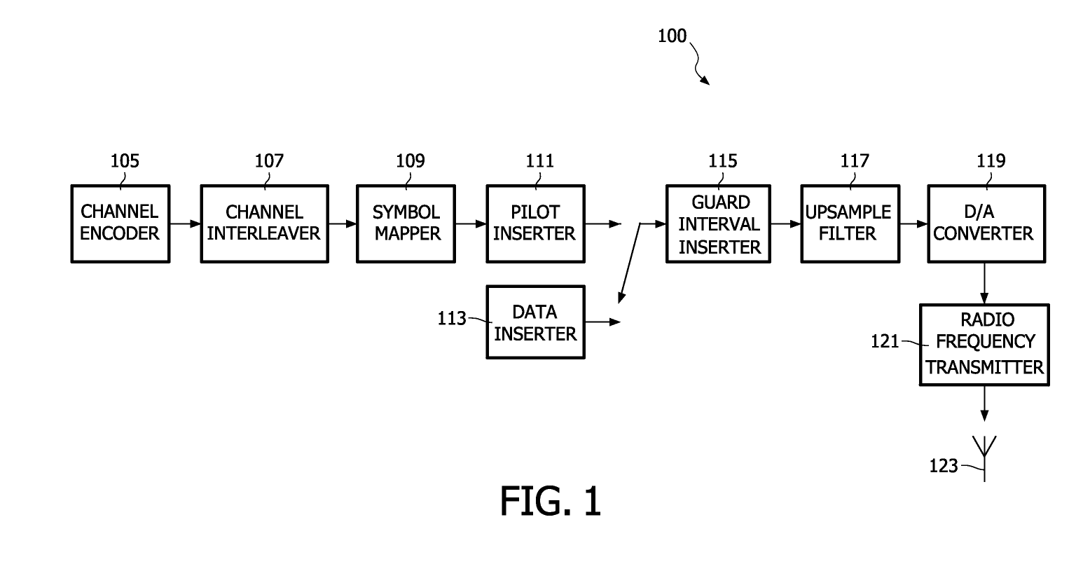

FIG. 1 is a functional block diagram of one embodiment of a data transmitter 100. As will be appreciated by those skilled in the art, the various functions shown in FIG. 1 may be physically implemented using a software-controlled microprocessor, hard-wired logic circuits, or a combination thereof. Also, while the functional blocks are illustrated as being segregated in FIG. 1 for explanation purposes, they may be combined in any physical implementation.

Data transmitter 100 includes a channel encoder 105, a channel interleaver 107, a symbol mapper 109, a pilot inserter 111, a data insertion module 113, a guard interval inserter 115, an upsample filter 117, and a digital-to-analog converter 119.

Channel encoder 105 channel-encodes an input information bit sequence according to a coding method. The channel encoder 105 can be a block encoder, a convolutional encoder, a turbo encoder, or some combination thereof including a concatenated code.

Channel interleaver 107 interleaves the coded data according to an interleaving method. While not shown in FIG. 1, it is clear that a rate matcher including a repeater and a puncturer can reside between the channel encoder 105 and the channel interleaver 107.

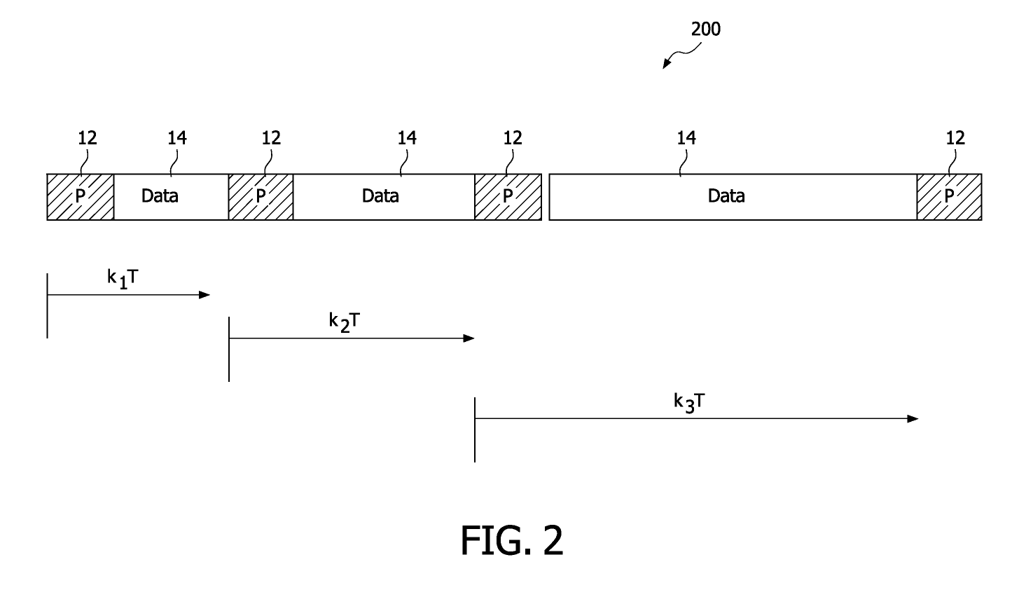

The data symbols output from the channel interleaver 107 are sent to a pilot inserter 111, where pilot symbols are inserted among the data symbols. The pilot inserter 111 generates pilot symbols which may be used to facilitate receiver detection of the transmitted signal. A more detailed description of the pilot symbols is discussed further below with reference to FIG. 2. Collectively, the data symbols and pilot symbols are referred to hereinafter simply as symbols. The symbols are passed to a guard interval inserter 115 to add prefixes to the symbols. The signals are then passed through an upsample filter 117, a digital-to-analog converter 121 and a radio frequency (RF) transmitter 121 which transmits SBCT symbols as a signal through a first transmitting antenna 123.

Guard interval inserter 113 includes a demultiplexer or switch 112 for selectively providing symbols output from the pilot inserter 111 or other data symbols, for example, from a training sequence.

Packet Structure

FIG. 2 is one embodiment of a structure of a data packet 200 that may be employed in a data transmission of a communication transmitter, according to one embodiment of the present invention. The data packet structure 200 is obtained by inserting short pre-amble packets 12, in a data stream to form discrete data sequences 14 separated by the pre-amble packets 12. The pre-amble packets are referred to hereafter as symbols 12. In accordance with a method of the invention, the symbols 12 are inserted into the data stream 14 at increasingly larger values of K_{N}T (where N=1, 2, 3, . . . ), where K_{N}T is the repetition interval (i.e., time insertion interval) of the sequence of symbols 12.

Data transmitter 100 transmits the symbols 12 at a variable repetition interval KT suitable for use with a conventional 20 ppm crystal. By transmitting the symbols 12 at a variable repetition interval KT, smaller values of KT allow a receiver 300 to obtain an estimation of a coarse frequency error. The coarse estimation is sufficient to allow a receiver 300 to perform initial correction (de-rotate) of a received signal. As the spacing of the transmitted symbols 12 becomes increasingly larger, by using larger values of KT, the frequency estimation error becomes correspondingly smaller and smaller Once a required accuracy is achieved, transmission of the symbol sequence 12 can be stopped. Alternatively, once a required accuracy is achieved, transmission of the symbol sequence 12 can continue using larger values of KT.

Receiver

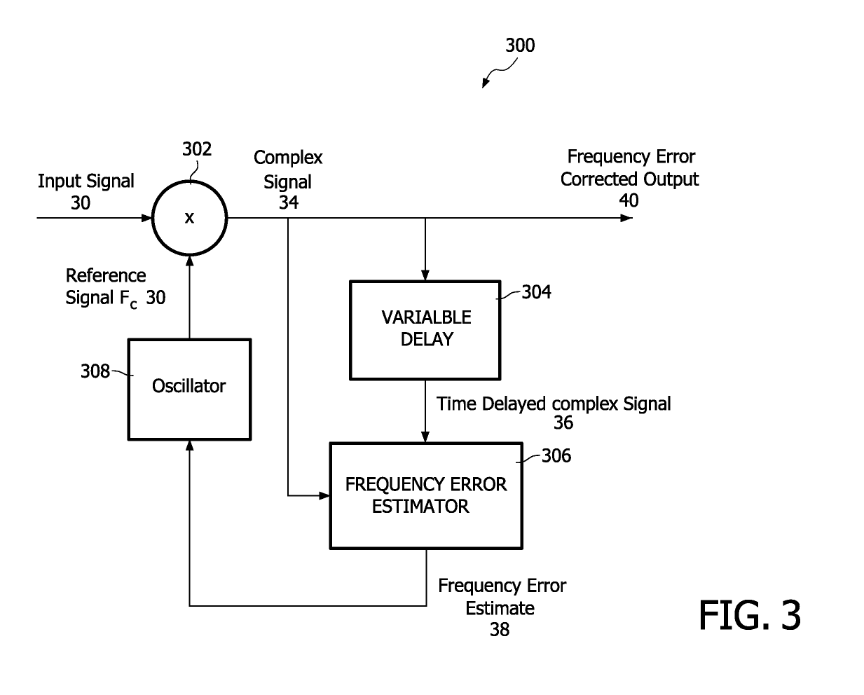

Turning now to FIG. 3, there is depicted a simplified exemplary embodiment of a data receiver 300. In the embodiment of FIG. 3, the data receiver 400 includes a complex mixer 302, a variable delay block 304, a frequency error estimation block 306 and a local oscillator 308.

In operation, an input radio signal 30, which is wirelessly received from radio transmitter 121 (see FIG. 1), is supplied as a first input to the complex mixer 302 where it is combined with a reference signal 32, output from oscillator 308, having a characteristic frequency f_{c} equal to the carrier frequency. A resulting complex signal 34 is processed by variable delay block 304 which is configured to delay the complex signal 34 by a known delay time to produce a time delayed complex signal 36. The time delayed complex signal 36 is supplied as one input to the frequency estimator block 306. The complex signal 34 is supplied as a second input to the frequency estimator block 306. Frequency error estimation block 308 is configured to determine the frequency characteristics of the frequency reference signal 32 and output a frequency error estimate 38 to the oscillator 308.

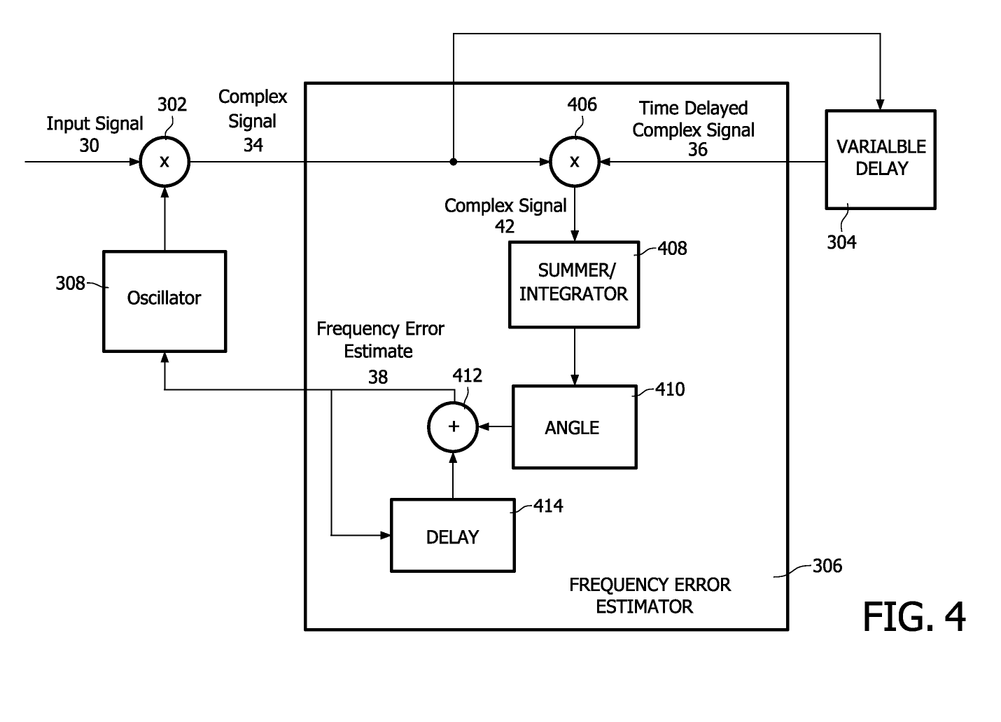

Turning now to FIG. 4, there is shown a more detailed block diagram of Frequency Estimation block 306. Frequency estimation block 306 is comprised of complex mixer 406, summer/integrator 408, angle estimator 410, an adder 412 and delay block 414. Complex mixer 406 and summer 408 perform a delayed auto-correlation operation on the two inputs. Specifically, frequency estimation block 306 receives two inputs, a first input, i.e., complex signal 34, which is output from complex mixer 302 and a second input, i.e., time delayed complex signal 36, output from variable delay block 304. The two inputs are combined in complex mixer 406 and produce a complex signal output 42 which is provided as an input to the summer block 408. These two operations collectively perform the delayed-auto-correlation operation described above with reference to FIG. 2, re-written here as Equation [6]. The complex mixer performs the multiplication portion of equation [6] and the summer/integrator block 408 performs the summing portion of equation [6].

$$f ( n ) = {\sum }_{m = 1}^{N} r ( nT - mT ) {r}^{*} ( nT - mT - KT ) \qquad Eq . [ 6 ]$$

The output of summing block 410 is then provided as an input to the angle estimation block 410 which calculates the angle of f(n). This is described above as equation [4], rewritten here as equation [7].

$${f}_{Δ}^{1} = {f}_{Δ} + \frac{{n}^{″}}{2 π KT} \qquad Eq . [ 7 ]$$

The angle estimate is provided as one input to the adder 412. The adder 412 receives a second input from delay block 414. Delay block 414 comprises the single element of a first order feedback loop and is configured to add previously computed frequency error estimates to the current frequency error estimate 38. The delay block provides a delayed frequency error estimate output to the adder 412 every e.g., TN seconds, where T is the sample period in seconds and N is the integration interval, as shown in equations [2] and [6]. Beneficially, by adding previously computed frequency error estimates to a currently computed frequency error estimate, the noise can be averaged out, thus providing a more accurate frequency error estimate.

Experimental Results

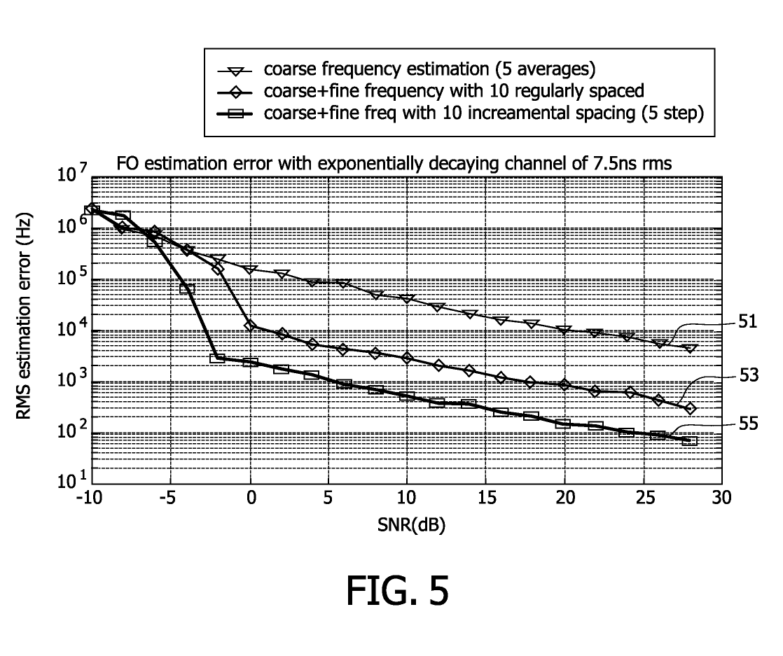

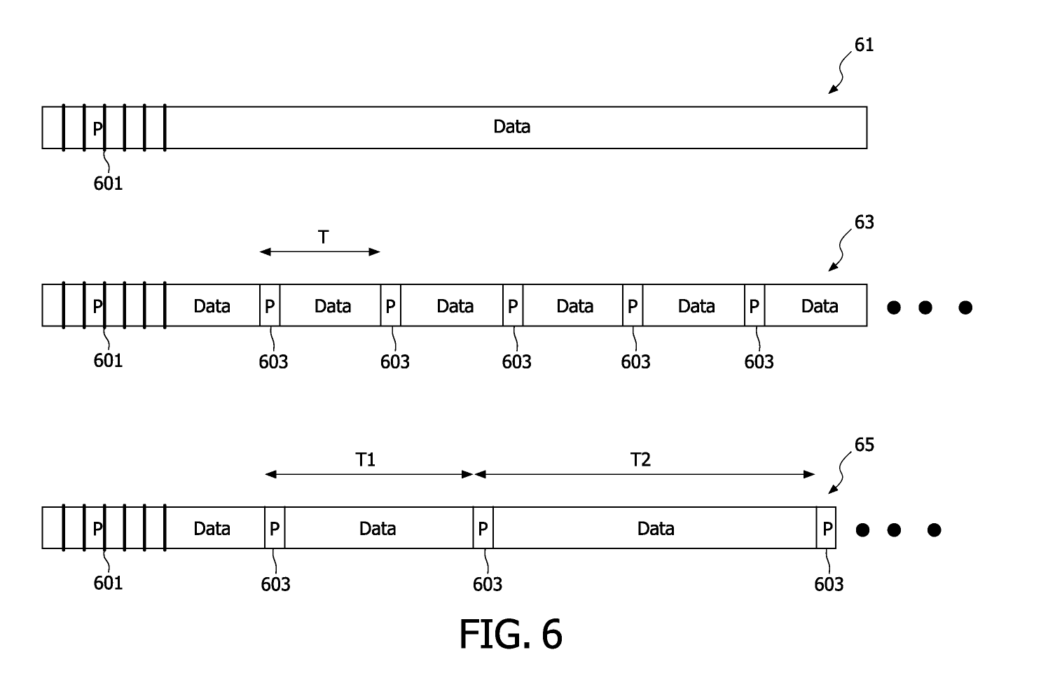

FIGS. 5 & 6 illustrate simulation results for three system configurations (FIG. 5) and corresponding data packet structures used in each of the respective three system configurations (FIG. 6). More particularly, FIG. 5 illustrates simulation results (curves 51 & 53) for two prior art system configurations, shown as simulation output curves 51 and 53 and a single simulation result, shown as output curve 55, for a system configuration according to an embodiment of the invention.

The three simulations were performed in accordance with the following parameters, which comprise typical parameters for a high-speed communication system operating at 60 GHz. A sampling rate of 1.4 GHz, a frequency offset of 2.4 MKHz (=40 ppm error at 60 GHz), and a random exponentially decaying channel with 7.5 ns delay spread.

Referring now to FIG. 6, there is shown respective data packet structures 61, 63 and 65 that were used in each of the respective three system configurations. The first data packet structure 61 was used in the baseline prior art system configuration. As shown, this data packet structure 61 includes 6 preamble sequences 601 that are inserted at the beginning of the first transmitted data packet to facilitate course frequency estimation at a receiver.

FIG. 6 further illustrates a second data packet structure 63, according to the prior art, which is included as a refinement of the baseline prior art system configuration. The second data packet structure 63 includes the 6 preamble sequences 601 of the baseline packet structure 61 and further includes 10 additional preamble packets 603, (five of which are shown), spaced at a regular interval, “T”, throughout the data packet structure 63 to provide a finer frequency estimation at a data receiver.

With continued reference to FIG. 6, there is also shown a third data packet structure 65, according to the invention. This inventive third data packet structure includes the 6 preamble sequences 601, as shown in packet structures 61, 63 and further includes 10 preamble packets 603 that are inserted at a progressively increased spacing (e.g., T1, T2, etc.), according to principles of the invention. Recall that the novel method of progressively spacing preamble packets was described in detail above with respect to FIG. 2. It is noted that the inventive third data packet structure 63 produces a simulation result 55 that is superior to the prior art packet structures 61, 63 by as much as 10 dB.

Although embodiments which incorporate the teachings of the present disclosure have been shown and described in detail herein, those skilled in the art can readily devise many other varied embodiments that still incorporate these teachings. Having described preferred embodiments for a system and method for efficient transmission of multimedia and data in the same packet (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the disclosure as outlined by the appended claims. Having thus described the disclosure with the details and particularity required by the patent laws, what is claimed and desired protected by Letters Patent is set forth in the appended claims.

What is claimed is:

1. A method for providing improved frequency estimation in a data communication system, the method comprising the steps of:
a) performing encoding, interleaving and symbol mapping on original information bits to form a data stream of modulated information symbols;
b) inserting pilot symbols at progressively longer time intervals into the data stream; and
c) transmitting the data stream as a radio signal from a data transmitter.

2. A method according to claim 1, further comprising the steps of:
receiving the data stream at a receiver; and
performing frequency error estimation using the received pilot symbols at the receiver.

3. A method according to claim 2, wherein the step of performing frequency error estimation using the received pilot symbols at the receiver, further comprises the steps of:
obtaining a coarse estimate of frequency error at the receiver using initially transmitted pilot symbols inserted into the data stream; and
obtaining finer estimates of said frequency error at the receiver using further transmitted pilot symbols inserted at said progressively longer time intervals in the data stream.

4. A method according to claim 3, further comprising the steps of:
determining when a required estimation accuracy is achieved at the receiver; and
halting the transmission of further pilot symbols in the transmitted data stream.

5. A method according to claim 3, further comprising:
determining when a required estimation accuracy is achieved at the receiver; and
adjusting the transmission rate of further pilot symbols in the transmitted data stream.

6. A method according to claim 5, wherein said transmission rate is adjusted downward when said required estimation accuracy is achieved.

7. A method according to claim 1, wherein said step (a) of inserting pilot symbols at a progressively longer time intervals into the data stream, further comprises:
inserting the pilot symbols into the data stream at an initial repetition interval of K₁T, where T is a sampling rate of said data symbols and K₁ is a positive integer; and
inserting pilot symbols at a progressively increased repetition interval K_{N}T, where K_{N} comprises a sequence of positive integers greater than K₁.

8. A method according to claim 7, wherein pilot symbols are inserted into said data stream at said initial repetition interval K₁T that is lower than the inverse of a maximum expected frequency error at the receiver.

9. A data transmission system, comprising a data transmitter comprising:
means for performing encoding, interleaving and symbol mapping on original information bits to form a data stream of modulated information symbols;
means for inserting pilot symbols at a progressively longer time intervals into the data stream;
means for transmitting the data stream as a radio signal from a data transmitter; and
means for receiving the radio signal by a receiver.

10. A data transmission system according to claim 9, further comprising a receiver: said receiver comprising means for performing frequency error estimation using the received pilot symbols at the receiver.

11. A data transmission system according to claim 9, wherein said means for inserting pilot symbols at progressively longer time intervals into the data stream, further comprises:
means for obtaining a coarse estimate of frequency error at the receiver using initially transmitted pilot symbols;
means for obtaining finer estimates of said frequency error at the receiver using further transmitted pilot symbols transmitted at said progressively intervals; and
means for determining when a required estimation accuracy is achieved at the receiver.

12. A data transmission system according to claim 11, further comprising:
means for halting the transmission of further pilot symbols in the transmitted data stream upon determining that a required estimation accuracy is achieved.

13. A data transmission system according to claim 11, further comprising: means for means for adjusting the transmission rate of further pilot symbols in the transmitted data stream upon determining that a required estimation accuracy is achieved.

14. A data structure for providing improved frequency estimation in a data communication system, comprising: a plurality of pilot symbols inserted into a data stream at progressively longer time intervals.

15. A data structure according to claim 14, wherein the data stream comprises a stream of modulated information symbols.

16. A data structure according to claim 15, wherein said stream of modulated information symbols are derived from encoding, interleaving and symbol mapping operations performed on an original stream of information bits.

17. A data structure according to claim 14, wherein said plurality of pilot symbols are inserted into said data stream at progressively longer time intervals corresponding to K_{N}T (where N=1, 2, 3, . . . ), where K_{N}T.

18. A data structure according to claim 17, wherein pilot symbols inserted into said data stream in accordance with smaller values of K_{N}T allow a receiver to obtain an estimation of a coarse frequency error.

19. A data structure according to claim 17, wherein pilot symbols inserted into said data stream in accordance with larger values of K_{N}T allow a receiver to obtain finer estimates of a frequency error.
